(19) United States
(12) Patent Application Publication
(10) Pub. No.: US 2007/0138407 A1
(43) Pub. Date: Jun. 21, 2007

(54) Rotary sample collector

(75) Inventors: Malcolm Bicknell Mcinnes, Fullarton (AU); Mark Redfern, Canning Vale (AU); Toby Day, Canning Vale (AU)

Correspondence Address: CALFEE HALTER & GRISWOLD, LLP, 800 SUPERIOR AVENUE, SUITE 1400, CLEVELAND, OH, 44114, US

(73) Assignee: SDS METAL CRAFT PTY LTD, Canning Vale (AU)

(21) Appl. No.: 10/576,433

(22) PCT Filed: Oct. 21, 2004
(86) PCT No.: PCT/IB04/04441

§ 371 Date: Nov. 7, 2006

(30) Foreign Application Priority Data
Oct. 21, 2003 (AU) 2003905774

(51) Int. Cl. G01N 21/00

(52) U.S. Cl. 250/453.11

(57) ABSTRACT

The invention relates to a sample collector apparatus (10) for collecting samples of flowable solid materials that comprises a housing (11) and a delivery opening (15) at the upper end of the housing (11) through which material to be sampled is delivered into the housing (11). A deflector (12) is located within the housing (11) and has an upper end (13) located below the delivery opening (15) and has an angled wall (14) that acts to deflect the material. A receptacle means (20) is located towards the lower edge of the deflector (12) for receiving a sample of the material flowing downwardly. The receptacle means (20) has an opening at (17) at its lower end through which the sample passes. Means 16 is provided for moving the receptacle means (20) with respect to the material flowing downwardly and a collection means (23) is located beneath the receptacle means (20) for collecting the sample from the opening (17) and a waste opening (26) is provided at the lower end of the housing (11) to discharge the portion of material not collected by the receptacle means (20). The invention provides a unique means of ensuring the random collection of a sample which is representative of the material as a whole that moves through the sample collection apparatus (10).

This invention relates to an improved material sample collector, and in particular to a sampling collection device for geological sampling materials; however, it should be appreciated that the invention is not necessarily limited to such materials and may have application in other technical fields where sampling of flowable solid materials is required.

In geological sampling, it is important that the sample collected be of a controlled portion and representative of the material being sampled so that subsequent testing of the sample reveals characteristics which can be realistically related to the whole of the bulk sample material and to their source. Problems which exist with known geological sampling material collection devices include variabilities in distribution and subsequent sampling catchment as a result of:
(i) particle size variation within the material;
(ii) moisture content variation within the material;
(iii) upstream material flow dynamics (average and flow cross-sectional velocity variation); and
(iv) stickiness of material, between the material particles and the collection surface of the sampling device, which can result in lumps.

It is the main object of the present invention to provide an improved sample collection apparatus which is designed for taking continuous and representative samples of material from a larger quantity of sampling material, in an extremely simple and effective manner.

It is another object of the present invention to provide an improved sample collection apparatus which is designed to allow samples of a pre-determined proportion of the total sampling materials flowing through the apparatus, to be collected.

It is a further object of the present invention to provide an improved geological sampling collection apparatus which is simple to construct and operate and which has the capacity to effectively operate with materials regardless of the moisture content thereof.

According to this invention therefore, a sample collector apparatus for collecting samples of flowable solid materials, comprises:
a housing
a delivery opening in the upper end of said housing through which material to be sampled is delivered into the housing,
a deflector within said housing having an upper end located below said delivery opening and having an angled wall that acts to deflect said material,
receptacle means towards the lower edge of said deflector for receiving a sample of said material flowing downwardly, said receptacle means having an opening at its lower end through which said sample passes,
means for moving said receptacle means with respect to said material flowing downwardly,
a collection means located beneath said receptacle means for collecting said sample from said opening, and
a waste opening at the lower end of said housing to discharge the portion of material not collected by said receptacle means.

Preferably the deflector is a vertically disposed cone having its upper apex end located approximately centrally beneath the delivery opening through which the material to be sampled is fed. In a preferred embodiment of the invention, the apex angle of the cone shaped deflector is approximately 51°. It will of course be appreciated that the angle of incline of the downwardly divergent walls of the deflector should not be less than the angle of the repose of the granular material being sampled. This also applies to the walls of the receptacle means and the collection means to thereby substantially eliminate any possibility of sample contamination when different sources of sampling material are processed at different times.

Preferably, the receptacle means is removably attached to the lower end of said deflector and projects radially outwards therefrom, whereby the deflector and the receptacle rotate together. Desirably the receptacle means is made in a range of different sizes so that the amount of sample material being collected can be varied. For example, in some instances, larger quantities of sampling materials may be required—in which case a larger width receptacle means is selected and attached to the deflector.

Desirably the means for moving the receptacle means comprises an hydraulic motor having a vertically disposed output drive shaft to which is mounted the deflector with the receptacle means mounted to the deflector. Alternatively, the deflector used to split the incoming stream of material to be sampled can be stationary with the receptacle means mounted on a rotating arm driven by the hydraulic motor so that the receptacle means rotates around the bottom perimeter edge of the stationary conical deflector.

In another preferred embodiment of the invention, the conical deflector is provided with a pair of receptacles means on opposite sides thereof, with the receptacles being arranged to collect and deliver respective portions of material into respective stationary sample collection chutes, each mounted below the conical deflector and its associated receptacle means, whereby two separate samples from the same source of materials can be collected and subsequently compared to ensure that representative samples have been taken.

In order to further explain the present invention, two preferred embodiments thereof are described hereunder in further detail with reference to and as illustrated in the accompanying drawings wherein:

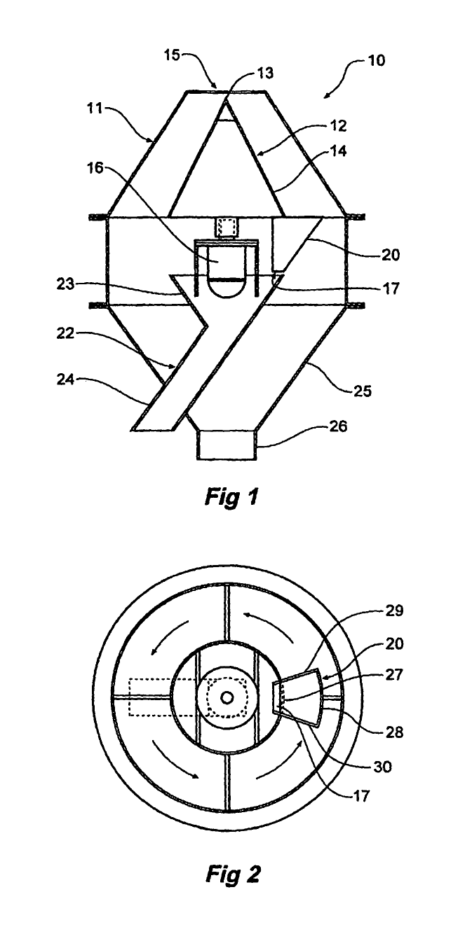

FIG. 1 is a schematic sectional elevational view of a sample collection apparatus made in accordance with a first preferred embodiment of the invention;

FIG. 2 is a sectional view along the line A A shown in FIG. 1;

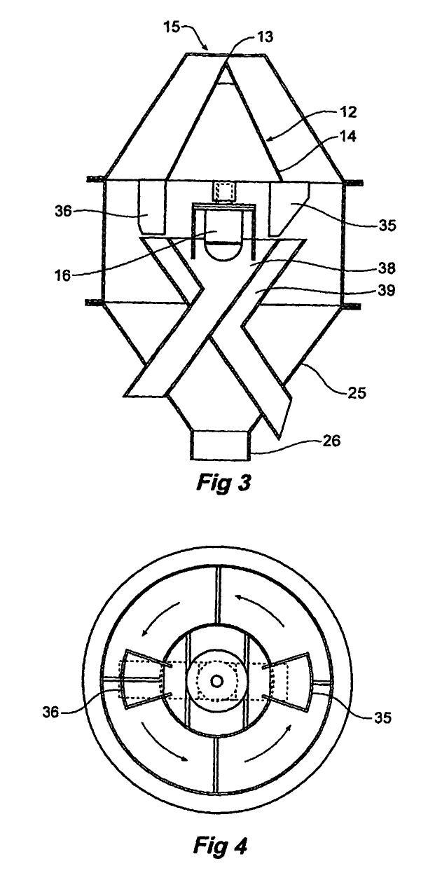

FIG. 3 is a view similar to FIG. 1 of a sample collection apparatus according to a second embodiment of the invention; while

FIG. 4 is a view similar to FIG. 2.

Referring to the embodiment shown in FIGS. 1 and 2 of the accompanying drawings, there is shown a sample collection apparatus 10 which includes a housing 11 which encloses a rotary conical deflector 12 which has its apex end 13 disposed approximately centrally beneath a material feed inlet opening 15 in the upper end of the housing 11 so that material flowing into the collector apparatus is separated or split into a number of streams which flow downwardly over the downwardly divergent wall 14 of the deflector 12.

In this embodiment, the conical deflector 12 is rotated by means of an hydraulic motor 16 which has its output drive shaft extending vertically upwards so as to coincide with the central vertical axis of the deflector 12.

Receptacle means is attached to the lower end of wall 14 of the deflector 12. The receptacle means projects radially outwards therefrom and comprises the sample receiving funnel-shaped receptacle 20. It rotates with the deflector 12 and is designed to collect a portion of the material flowing downwardly over the deflector wall 14. The funnel-shaped receptacle 20 has downwardly convergent walls terminating in an opening 17 arranged so that, during rotation of the receptacle 20, the material collected by the receptacle 20 is delivered into the open upper end of a stationary sample collection chute 22. In this embodiment the sample collection chute 22 comprises an upper funnel portion 23 which joins to a downwardly inclined discharge tube 24 that exits the housing 11 and is arranged to discharge the material delivered into the funnel portion 23 into a sample bag or receptacle positioned over the open bottom end of the tube 24.

A funnel-shaped waste chute 25 is attached to the bottom end of the housing 11 and is shaped and sized so as to collect the non-sampled portion of the material flowing through the collector apparatus 10 for discharge to waste. In this embodiment the waste chute 25 forms an integral part of the housing 11 and has its bottom discharge end 26 substantially below the central vertical axis of the housing.

As shown in FIG. 2 of the drawings, the sample receiving receptacle of funnel 20 has inner and outer walls 27, 28 respectively which are interconnected by radially extending side walls 29, 30 which converge radially inwards, with the outer wall 28 sloping inwardly from its upper end to its lower end, with the angle of slope for each of the walls being sufficient to ensure that material fed into the receptacle 20 does not stick thereto. In this embodiment the sample receiving receptacle 20 is removably fitted to the bottom edge of the deflector 12 and hence can be readily replaced with a new receptacle or a receptacle having a different width so that a different proportion of the sampling material flow through the collector apparatus can be collected and sampled.

Referring to the embodiment of the invention shown in FIG. 3 of the drawings, the sample collector apparatus is modified so that it provides duplicate sampling capabilities by having a pair of diametrically opposed sample receiving receptacles 35, 36 attached to opposite sides of the conical deflector 12 and a pair of stationary sample collection chutes 38, 39 for respectively collecting material sample portions delivered by the receptacles 35, 36. In this way duplicate representative samples can be collected and tested to ensure that both samples have consistent characteristics and hence are truly representative of the material being sampled.

In the second embodiment, the sample receiving receptacle 36 extends further vertically downwards than that of the other diametrically opposite sample receiving receptacle 35, while its associated sample chute 39 has its open upper end disposed at a lower level than that of the other collection chute 38.

It should of course be appreciated that the receiving receptacles 35, 36 do not have to communicate with their associated collector chutes 38,39 during an entire revolution thereof. In some instances, the collection chutes can be arranged so that collected material discharges into the collection chutes during part only of their rotational movement.

In a non-illustrated variation of the present invention, the conical deflector 12 is mounted as a stationary member within the housing while the sample receiving receptacle or port is arranged to be rotated by suitable drive means, whereby the deflector and the receptacle rotate relative to one another.

It will of course be appreciated that for different types of granular or particulate materials to be sampled, the size of the included apex angle of the conical deflector may need to be varied, as may also the rotational speed of the deflector (or the rotational speed of the receiving receptacles in the situation where the deflector is stationary). A rotational speed of around 14 rpm has been found to be most preferred. These are variables which essentially depend on the type of material to be sampled, and in particular the amount of its moisture content—it being appreciated that very moist material will tend to stick onto the surfaces of the components of the collection apparatus.

A brief consideration of the abovedescribed embodiments will indicate that the invention provides a very simple and effective sample collection device for geological sampling and which allows a controlled proportion representative of a large quantity of sampling material, to be collected—regardless of the particle size variation, moisture content variation and stickiness of the material to be sampled.

Although the invention has been described herein by reference to specific embodiments, it is not intended to be limited thereto but to include any variations and modification which fall within the true spirit and scope of the invention.

1. A sample collector apparatus for collecting samples of flowable solid materials comprising: a housing a delivery opening in the upper end of said housing through which material to be sampled is delivered into the housing, a deflector within said housing having an upper end located below said delivery opening and having an angled wall that acts to deflect said material, receptacle means towards the lower edge of said deflector for receiving a sample of said material flowing downwardly, said receptacle means having an opening at its lower end through which said sample passes, means for moving said receptacle means with respect to said material flowing downwardly, a collection means located beneath said receptacle means for collecting said sample from said opening, and a waste opening at the lower end of said housing to discharge the portion of material not collected by said receptacle means.

2. A sample collector apparatus according to claim 1 wherein said deflector comprises walls that diverge downwardly.

3. A sample collector apparatus according to claim 1 wherein said deflector is conically shaped with its narrow end uppermost and located near said delivery opening.

4. A sample collector apparatus according to claim 3 wherein said receptacle means is secured to the lower peripheral edge of said deflector and wherein said means for moving said receptacle means is a drive means that rotates both said deflector and said receptacle means.

5. A sample collector apparatus according to claim 4 wherein said drive means comprises an hydraulic motor.

6. A sample collector apparatus according to claim 4 wherein said receptacle means is removably attached to said deflector.

7. A sample collector apparatus according to claim 1 wherein said collection means comprises a funnel located beneath the range of movement of said receptacle means having a discharge end located outside of said housing.

8. A sample collector apparatus according to claim 1 wherein said receptacle means having walls defining a rectilinear opening, said walls converging to said opening.

9. A sample collector apparatus according to claim 1 comprising two receptacle containers.

10. A sample collector apparatus according to claim 9 further comprising two collection means, a first for collection of the sample from the first receptacle means, and a second collection means for collection of the sample from the second receptacle means.

11. A sample collector apparatus according to claim 10 wherein said first and second collection means comprise funnels with said second collection means located centrally within said first collection means and wherein said opening of said first receptacle means is located over an annulus formed between said first and second collection means and said opening of said second receptacle means is located over said second collection means.

12. A sample collector apparatus according to claim 11 wherein the discharge of said second collection means exits a wall of said first collection means.

13. A sample collector apparatus according to claim 1 substantially as herein described with reference to the accompanying drawings.

14. A sample collector apparatus according to claim 5 wherein said receptacle means is removably attached to said deflector.
